(19) United States
(12) Patent Application Publication
(10) Pub. No.: US 2024/0184638 A1
(43) Pub. Date: Jun. 6, 2024

(54) COST AWARE SERVICE MESH RESOURCE MANAGEMENT

(71) Applicant: International Business Machines Corporation, Armonk, NY (US)

(72) Inventors: Sudheesh S. Kairali, Kozhikode (IN); Sarbajit K. Rakshit, Kolkata (IN)

(21) Appl. No.: 18/060,995

(22) Filed: Dec. 2, 2022

(51) Int. Cl. G06F 9/50

(52) U.S. Cl. CPC G06F 9/5083; G06F 9/5072; G06F 2209/5019

(57) ABSTRACT

A system may include a memory and a processor in communication with the memory. The processor may be configured to perform operations. The operations may include acquiring historical data and identifying a pattern in the historical data. The operations may include predicting a predicted task request based on the historical data and the pattern such that the predicted task request anticipates a task request. The operations may include calculating predicted resource requirements for the predicted task request and allocating resources for the predicted task request. The operations may include receiving the task request, assigning the allocated resources to the task request, and deploying the allocated resources for the task request.

### BACKGROUND

The present disclosure relates to distributed systems, and, more specifically, to workload management in distributed systems.

Workload scheduling and workload distribution are common functions in the computer field, including in distributed systems. Distributed systems may include, for example, open-source container systems. Open-source containers offer adaptive load balancing, service registration, deployment, operation, resource scheduling, and capacity scaling.

Certain workloads, such as transient container applications, may temporarily use host resources such that a host may have additional resources available for one or more other workloads after its completion. A system management goal may be to maximize utilization of the system without negatively impacting performance. In distributed systems such as open-source container systems, this may include maximizing the use of existing hosts before initiating additional hosts.

### SUMMARY

Embodiments of the present disclosure include a system, method, and computer program product for workload management in distributed systems.

A system may include a memory and a processor in communication with the memory.

The processor may be configured to perform operations. The operations may include acquiring historical data and identifying a pattern in the historical data. The operations may include predicting a predicted task request based on the historical data and the pattern such that the predicted task request anticipates a task request. The operations may include calculating predicted resource requirements for the predicted task request and allocating resources for the predicted task request. The operations may include receiving the task request, assigning the allocated resources to the task request, and deploying the allocated resources for the task request.

The above summary is not intended to describe each illustrated embodiment or every implementation of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a workload management system in accordance with some embodiments of the present disclosure.

FIG. 2 depicts a workload management system in accordance with some embodiments of the present disclosure.

FIG. 3 illustrates a computer-implemented workload management method in accordance with some embodiments of the present disclosure.

FIG. 4 depicts a computer-implemented workload management method in accordance with some embodiments of the present disclosure.

FIG. 5 illustrates a computer-implemented workload management method in accordance with some embodiments of the present disclosure.

FIG. 6 depicts a block diagram illustrating an embodiment of a computer system, and the components thereof, upon which embodiments described herein may be implemented in accordance with the present disclosure.

FIG. 7 depicts a block diagram illustrating an extension of the computing system environment of FIG. 6 wherein the computer systems are configured to operate in a network environment (including a cloud environment) and perform methods described herein in accordance with the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to distributed systems, and, more specifically, to workload management in distributed systems.

The philosophy of legacy services is deeply different from that of microservices. Moving from legacy services to microservices introduces various challenges. In a cloud-based environment, a lot of data may be transferred between many microservices. A service mesh architecture allows for building and/or managing a chain of microservices. The control plane of the service mesh allows for control of the microservices including the networking and/or the dataplane. The control plane may include a set of proxies that may be injected into each individual microservice to facilitate communication between services; the communication may be done via proxy-to-proxy communication.

For an individual service, a load increase may result in the load balancer dynamically scaling the service, resulting in the use of more cloud resources. Based on the increase in resource consumption, the service cost may also increase. Some requests may be duplicative, but the additional resources are consumed even for duplicative requests. There can be prioritization and/or a comparative priority between applications; in such a scenario, an artificial intelligence (AI) system may be used to adjust requests to place a cap on and/or minimize overall costs for a user. For example, an AI system may identify various task requests from a user and assign resources to each request at a certain time based on prioritization.

In some embodiments of the present disclosure, the service mesh architecture may be optimized. For example, a system may predict when a specific user, user group, or organization will need certain resources such as storage space or a data pull; the system may use the prediction to plan ahead for that resource use.

Some embodiments of the present disclosure may include a service mesh control plane with request aggregation modules. The service mesh control plane may use historical data to predict and allocate resources. The service mesh control plane may receive the historical data from a data source (e.g., downloaded from a previous database to a new corpus) or the service mesh control plane may collect the data as the requests are processed (e.g., via a data collection module). Historical data may include, for example, individual requests, expected time to complete requests, actual time to complete requests, cloud resource required to complete requests, the timelines for submitting different requests, and the like. In some embodiments, the service mesh may consider a user profile in the historical data and/or as a mechanism for construing the data.

A module may be used to identify which requests may be aggregated to reduce the number of unique requests submitted to the service mesh. By aggregating requests, the aggregated resource consumption may be reduced compared to the resource consumption that would be required for submitting the requests individually. Resource consumption of a system may thus be optimized and/or minimized.

In some embodiments, a service mesh may have a request de-duplication module to remove duplicative requests such that only unique requests are sent to an execution unit (e.g., the services that are to perform the actual requested services). Such a de-duplication module may enable optimizing and/or minimizing resource consumption. In some embodiments, a service mesh may identify duplicative requests and de-duplicate the requests at or near the beginning of a request processing chain. In some embodiments, the assessment (e.g., identifying a phase such as a beginning) of the request processing chain may be based, in whole or in part, on a predicted processing chain for a particular user profile. In some embodiments, the request processing chain may be assessed for microservices and/or based on norms for a microservice system.

A service mesh control plane may have a cost validation module for a defined time range or cycle. A cycle may be time-based such as hourly, daily, weekly, every Tuesday and Friday, monthly, quarterly, annually, and the like. A cycle may be a billing cycle such as the time an invoice is or will be billed for, a compilation of invoices (e.g., a set of invoices for a quarter or for a year). In some embodiments, a service mesh module may predict a need based on the context of the system, user profile, and/or other historical data; the service mesh module may prioritize (based on settings, manual input, or a combination thereof) request aggregation, de-duplication, holding, and/or processing based on the predicted need and context.

Prioritization may be done such that each of the requests may be maintained by the system. Prioritization considerations may include, for example, a service level agreement (SLA), a service level objective (SLO), or some combination of SLAs and/or SLOs. Prioritization may consider one or more chains for each relevant user profile; for example, three user profiles may be serviced by a first cluster and five user profiles may be serviced by a second cluster, one service mesh may service both clusters, and the service mesh may consider only the requests for the three user profiles while queuing and/or prioritizing tasks for the first cluster and only consider the requests for the five user profiles while queuing and/or prioritizing tasks for a second cluster.

In some embodiments, a service mesh may predict costs involved in processing one or more requests; such cost predictions may be completed at or near the beginning of a chain. Predicting a cost at or near the beginning of a processing chain may enable user awareness of expenditures that may be accrued as a result of a request.

A system in accordance with the present disclosure may use the results from a request aggregator module and/or request de-duplication module to identify one or more services within a chain to be scaled (e.g., scaled up, scaled down, scaled out, or scaled in) to meet resource demand. The services may be scaled and/or scheduled based on SLA, SLO, and/or cost range. A cost range may be, for example, a budget allocated for services rendered for a predetermined time period, a cap on the total price an entity will pay during a contract, or the like. A user may define a cost range manually or automatically based on settings and/or one or more inputs.

In some embodiments, resources may be scaled to meet demand at a time of actual demand, predicted demand, scheduled resource availability, SLA or SLO schedule times, or the like. In some embodiments, one or more tasks may be scheduled or delayed to maintain maximum resource utilization. The timing of submission of a task to a task execution unit may be based on SLA, SLO, cost range, task urgency, task importance, resource availability, resource utilization rates, predicted resource availability, predicted resource utilization rates, predicted costs, peak versus off-peak resource rates, and the like.

A user may set a cost range and submit task requests to a service mesh control plane. The service mesh control plane may predict that the charges for completing the task requests would be in excess of the allocated budget. The service mesh control plane may perform a contextual analysis of the requests based on historical data. The service mesh control plane may use the contextual analysis data to prioritize the task requests to remain within a cost range. Prioritization may determine whether tasks are performed immediately, scheduled or delayed, and/or deleted without being performed based on settings and/or user input. In some embodiments, the service mesh control plane may notify a user of the task prioritization and request confirmation before acting on the prioritization (e.g., before executing, scheduling, or cancelling a task request).

The service mesh control plane may submit a task to a computation unit for execution. The computation unit may execute the task and return a result to the service mesh control plane. In some embodiments of the present disclosure, the service mesh control plane may aggregate and/or de-duplicate several tasks and submit an aggregated task to the computation unit. The computation unit may execute the aggregated task and return an aggregated result to the service mesh control plane; the service mesh control plane may split the aggregated result into results for each of the several tasks originally submitted. The service mesh may use a splitting module to split the aggregated result into the results for each of the several tasks; a splitting module may also deliver the results to respond to the several tasks.

For example, a service mesh control plane may service ten users; each of the ten users may submit a task request, and each of the task request may be the same from all of the users. The service mesh may aggregate the requests, de-duplicate the requests, and submit an aggregated task request to a computation unit. The computation unit may respond to the aggregated task request and submit the aggregated result to the service mesh. The service mesh may receive the aggregated result, split the aggregated result into responses for each of the ten users, and send each user a task result in response to the original inquiry of the user.

The present disclosure may also be used when task requests may be similar but not identical. In such circumstances, the aggregated request may contain a core or consolidated task request that is the shared task request as well as one or more addendum or related task requests that cover any unique portions of the task requests. In some embodiments, the resource cost of submitting the tasks individually, executing the tasks, and submitting the results to the requester(s) may be compared to the resource cost of aggregating the tasks, submitting the aggregated task, executing the aggregated task, splitting the aggregated task, and submitting the split results to the requester(s). In some embodiments, a comparison may be made to enable the system and/or a user (e.g., administrator) to select an option for individual or aggregated submission based on, for example, the comparison and/or resource use (e.g., computing power and time).

The service mesh control plane may enable the minimization of cost for an entity (e.g., person or organization) using a service. The entity may define a cost, set preferences, and submit task requests, and the service mesh may prioritize the task requests, identify which tasks will be satisfied based on the parameters set by the entity, notify the entity of the task completion predictions, submit the task requests to a computation unit, receive the results from the computation unit, and return the results to the entity.

In some embodiments of the present disclosure, a system may collect historical data. The system may collect the historical data by tracking requests as they pass through the service mesh and/or by receiving a data collection (e.g., via an upload of historical data). The historical data may include task numbers, types, times, resource requirements, execution reports, dimension types, measurements, filter selections, and the like. Each request submitted by a user for execution by a cloud computation unit may be individually identified.

A system in accordance with the present disclosure may identify a number of concurrent users and a number of concurrent requests; the system may use this data to identify whether a cloud resource is to be scaled. The system may scale up, scale out, scale down, and/or scale in one or more cloud resources based on the requested resource use as well as a defined cloud cost cap. An entity may determine a cloud cost cap automatically or manually; for example, certain settings and/or preferences may define the cloud cost cap (based on, e.g., anticipated sales figures), or the administrator for a group of users may define a cloud cost cap (based on, e.g., resource need predictions and project urgency).

A system in accordance with the present disclosure may identify and analyze historical requests to collect and/or bolster a historical database. The system may identify the similarity of a newly submitted request to one or more historical requests by analyzing the newly submitted request; in some embodiments, an analysis module will analyze and/or identify requests for similarity. Requests may be assessed for similarity based on, for example, type of request, submission time, user preference inputs (e.g., an urgency rating or prioritization note), query input, filter conditions, attribute selection, and the like.

A system in accordance with the present disclosure may use an aggregation module to aggregate similar requests. The request aggregation module may analyze requests to identify multiple requests can be aggregated to generate a single request. The system may identify similarities between requested tasks and/or historically requested tasks during request aggregation. The system may identify which types of requests may be aggregated and/or which types of requests may be executed via the computation unit (e.g., whether a task may be executed in a cloud server). The system may identify which requests may be aggregated into an aggregated request such that the aggregated request may be submitted for execution as a single request.

A system in accordance with the present disclosure may use a request de-duplication module to de-duplicate task requests. In some embodiments, a validation unit may be used to check the determination that the requests are duplicative; in some embodiments, the validation unit may be a separate module on the service mesh control plane, and in some embodiments, the request de-duplication module may include a validation unit. In some embodiments, the system may use artificial intelligence (AI) to determine whether requests can be aggregated and/or whether the requests are duplicative; in some embodiments, the AI may assess requests for the ability to aggregate and/or de-duplicate as the requests are received.

The system may identify how the requests can be aggregated; in some embodiments, the system may use historical data and the analysis thereof to determine how to optimally aggregate requests. If the system identifies that there are duplicative requests, the system may determine which other requests are duplicative such that the duplicative requests may be batch de-duplicated. The system may reduce the number of unique tasks to be executed by a computation unit by aggregating (e.g., via an aggregation module) and de-duplicating (e.g., via a de-duplication module) the task requests.

The system may identify whether a reduction in the task request count will reduce the predicted resource consumption when considering any changes in requests made necessary by aggregation. For example, if ten task requests are submitted with a core task request (such that there is a central consolidated task) and six addendum or related task requests, the system may determine whether it is more advantageous to submit the core task with six addendum task requests or whether that would use more resources than submitting the task requests individually. In such an example, the system may determine that it is advantageous to submit four of the six task requests with addendum task requests individually and that the remaining six task requests may be submitted as an aggregated request. The system may determine which configuration of task completion will optimize resources and submit tasks to a computation unit accordingly.

In some embodiments of the present disclosure, a system may identify cloud resources. The system may identify the cloud resources, for example, for a defined cycle (e.g., a day, a month, or a billing cycle). The system may identify cloud resources for a defined cycle that have been allocated; the resources identified may be allocated for a particular entity (e.g., an organization or a user) and/or for a particular task. In some embodiments, the system may identify cloud resources that are allocated for other tasks; for example, the system may identify that certain resources are reserved for certain tasks that are scheduled and/or predicted for certain times. The system may identify resources as either available or unavailable for tasks at certain times. The system may identify cloud resources allocated for a predicted, incoming task during a defined cycle.

A system in accordance with the present disclosure may use prioritization of request types. For example, a user may determine that the system should prioritize certain types of requests (e.g., computing a financial report) over other types of requests (e.g., compressing and archiving emails); the user may define a prioritization metric, submit the prioritization metric to the system, and the system may implement the prioritization metric such that scheduled and/or predicted tasks account for the prioritization. The system may use a defined priority to prioritize which requests are to be processed immediately, scheduled for later, held for a low resource utilization time, or similar. Prioritization may be set automatically (e.g., resource provider presets), manually (e.g., a user entering each priority), or some combination thereof (e.g., an entity having base presets for organization prioritization and an administrator in the organization customizing prioritization for particular business groups and/or tasks).

A system may use a load balancer to identify task request processing prioritization, cloud resource scaling, and/or task execution. For example, a load balancing module may identify that three tasks are to be processed immediately, that the necessary resources are unavailable, and that the resources may be scaled in accordance with the SLA so as to execute the tasks. In another example, a load balancer may determine that only two of the three tasks need to be processed immediately, that one of the tasks should be delayed according to prioritization rules, and that the SLA permits scaling of resources to accommodate the two tasks pending immediate deployment.

A system in accordance with the present disclosure may include a service mesh control plane with at least one aggregation module. Aggregation modules may use data to aggregate task requests; the data may include historical data. Historical data may include, for example, one or more individual requests, the expected time to complete the requests, the cloud resources necessary to complete each request, the time each request was submitted, and the like. The service mesh control plane may consider a user profile as a dimension; for example, a user profile may be used to identify whether multiple requests may be aggregated.

A system in accordance with the present disclosure may identify requests that may be aggregated and aggregate the requests to reduce the number of unique requests submitted for execution. As a result of aggregating like requests, the resource consumption for executing the requests may be reduced and the overall resource consumption may be minimized.

In some embodiments, a computation unit may execute the aggregated request to render an aggregated result. The service mesh control plane may split the aggregated result into individual results. The individual results may be delivered to individual requesters. In some embodiments, a splitting module may be used to split the aggregated result and deliver the individual results to the individual requesters.

In some embodiments, a service mesh may include a request de-duplication module. The request de-duplication module may remove duplicative requests such that only unique requests are submitted for computation. Removing duplicative requests may facilitate optimizing and/or minimizing resource consumption. In some embodiments, the de-duplication may occur at the beginning of the processing chain so as to optimize and/or minimize resources for the maximum amount of the processing chain so as to maximize the benefit of de-duplication. In some embodiments, the placement of the de-duplication in the process (e.g., at the beginning versus immediately preceding computation) may be based on various factors such as, for example, the user profile of the requester, a predicted microservice chain, or some combination thereof.

In some embodiments, a service mesh may predict that a request will exceed a resource budget. The service mesh may perform contextual analysis of the requests to prioritize the requests and/or identify which requests may be delayed to remain within the defined resource budget.

In some embodiments of the present disclosure, a system may be used to optimize a service mesh architecture. In some embodiments, the disclosure may be used to predict when a specific user, group, or organization will need certain resources (e.g., storage, computation, or data pull) and plan ahead specifically for the predicted resource use.

A system in accordance with the present disclosure may include a service mesh control plane with a cost validation module. The cost validation module may check budgets and/or resource costs for a defined time range (e.g., a week or a billing cycle). The service mesh control plane may predict resource consumption and prioritize requests accordingly. The service mesh control plane may prioritize execution of requests, both aggregated and individual. The service mesh control plane may prioritize which requests are to be aggregated prior to execution. The service mesh control plane may determine which requests (whether aggregated or not) are to be aggregated, delayed, scheduled for execution, and/or submitted for immediate execution.

The service mesh control plane may determine how to handle requests so as to optimize resources while maintaining any relevant SLA and/or SLO. The service mesh may prioritize and/or determine actions for task requests based in part on user profiles, microservice processing chains, and/or the specific microservice processing chains for any relevant user profiles. The service mesh may predict resource cost and/or availability at the beginning of the processing chain. The service mesh may be aware of the processing chains for each of the relevant user profiles and may predict the resource cost considering the relevant processing chains.

In some embodiments, a system may identify whether services and/or resources are to be scaled. The system may identify that a defined cost range, request aggregator results, and/or request deduplication results indicate that scaling services and/or resources is appropriate. The system may determine that the services and/or resources may be scaled to meet demand and that a defined budget or cost range permits such scaling. The system may determine that the SLA and/or SLO may require scaling and may thus scale the available services and/or resources. In some embodiments, the system may identify that the SLA or SLO may be delayed so as to maintain a maximum resource utilization and/or other defined constraints (e.g., budget).

A system may include a memory and a processor in communication with the memory. The processor may be configured to perform operations. The operations may include acquiring historical data and identifying a pattern in the historical data. The operations may include predicting a predicted task request based on the historical data and the pattern such that the predicted task request anticipates a task request. The operations may include calculating predicted resource requirements for the predicted task request and allocating resources for the predicted task request. The operations may include receiving the task request and assigning the allocated resources to the task request. The operations may include deploying the allocated resources for the task request.

In some embodiments of the present disclosure, the operations may include calculating a predicted resource requirement for the predicted task request. In some embodiments of the present disclosure, the operations may further include forecasting available resources during a future deployment time window and scheduling the predicted task request based on the available resources. In some embodiments of the present disclosure, the operations may further include detecting an existing resource allocation schedule and scheduling the predicted task request in the existing resource allocation schedule.

In some embodiments of the present disclosure, the operations may include scaling resources for the predicted task request.

In some embodiments of the present disclosure, the operations may include prioritizing the task request among a set of tasks.

In some embodiments of the present disclosure, the operations may include balancing a task load based on system resource availability. The task load may include the task request and a set of tasks.

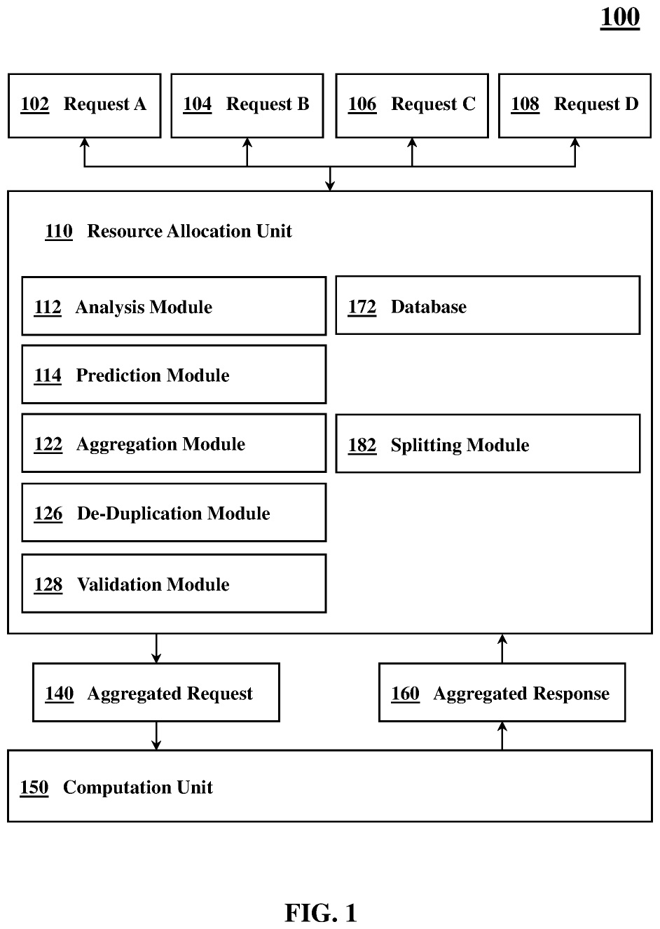

FIG. 1 illustrates a workload management system 100 in accordance with some embodiments of the present disclosure. The workload management system 100 includes a resource allocation unit 110 and a computation unit 150. The resource allocation unit 110 receives requests 102-108, submits an aggregated request 140 to the computation unit 150, receives an aggregated response 160 from the computation unit 150, and submits responses to the requests 102-108 based on the aggregated response 160.

The resource allocation unit 110 receives requests 102-108. The resource allocation unit 110 analyzes the requests 102-108 with an analysis module 112. The analysis module 112 may produce data for the prediction module 114, aggregation module 122, de-duplication module 126, validation module 128, database 172, and/or splitting module 182.

The prediction module 114 may predict the resources necessary and/or available to execute the requests 102-108. In some embodiments, the prediction module 114 may predict the resource use of the execution of the requests 102-108 if submitted to the computation unit 150 individually as well as the resource use of aggregating and executing the requests 102-108 as an aggregated request 140. In some embodiments, the prediction module 114 may generate one or more comparisons of the resources necessary for the requests 102-108 submitted individually, a single aggregated request 140, or some combination thereof (e.g., three requests 102-106 submitted to the computation unit 150 for execution as an aggregated request 140 and one request 108 submitted to the computation unit 150 for execution individually).

The aggregation module 122 may determine which requests 102-108 may and/or may not be aggregated into an aggregated request 140. The aggregation module 122 may aggregate the requests 102-108 that may be aggregated into an aggregated 140 request for submission to a computation unit 150 for execution.

The de-duplication module 126 may de-duplicate any duplicative requests. For example, the requests 102-108 may be aggregated into an aggregated request 140 and the de-duplication module 126 may mark the original requests 102-108 as not for execution; in other words, the de-duplication module 126 may either delete the original requests 102-108 or indicate to the system 100 that the original requests 102-108 are not to be sent to the computation unit 150. In some embodiments, the de-duplication module 126 may be used to identify, mark, and/or delete duplicative requests so as to optimize resource use in accordance with a relevant SLA and/or SLO.

The validation module 128 may be used to validate one or more analyses, predictions, aggregations, duplicative request assessments, restrictions (e.g., SLA or budgetary confines), time bounds (e.g., length of a billing cycle or type of time range), response splits, resource directions, and the like. The validation module 128 may validate/approve results from one or more modules. The validation module 128 may invalidate results from one or more modules and require action prior to proceeding; for example, the validation module 128 may determine that the de-duplication module 126 erred and thus requires re-calculation of the de-duplication evaluations before deleting any of the individual original requests 102-108.

The resource allocation unit 110 may send the aggregated request 140 (e.g., aggregated by the aggregation module 122) to the computation unit 150. The computation unit 150 may execute the aggregated request 140 (e.g., perform one or more calculations and/or searches) to achieve an aggregated response 160 to the aggregated request 140. The computation unit 150 may send the aggregated response 160 to the resource allocation unit 110.

The resource allocation unit 110 may use a splitting module 182 to split the aggregated response 160 into individual responses to each of the original requests 102-108 and submit the individual responses to the proper original requestors.

Data (e.g., results from any of the modules in the resource allocation unit 110) and/or requests 102-108 may be stored in the database 172 to build the historical data record. The database 172 may include data from and/or about requests submitted to the system 100 and/or data received from an external data collection. The analysis module 112 may analyze both incoming requests 102-108 and historical data stored in a database 172. The analysis module 112 may render an analysis to a prediction module 114. The prediction module 114 may use the analysis to determine and/or enhance a predicted task schedule and/or one or more predicted resource allocations for predicted requests projected to be submitted to the system 100.

Data in the database 172 may be used to generate a predicted schedule of tasks for one or more users. In some embodiments, the data may be used to optimize resource availability and/or expenditure by scheduling regular tasks. For example, the analysis module 112 may identify a pattern in the data that a user requests the numbers for a particular financial report be run every Monday at noon, that the data requested for that report includes all of the data from the previous week that ended Saturday, and that the energy cost to run the reports is lowest on Sunday morning; the system 100 may prompt the user on Friday to request permission to run the report on Sunday morning so as to use off-peak energy costs to have the report ready for the user on Monday. In some embodiments, an administrator may identify one or more thresholds to trigger automatic scheduling of regular tasks (e.g., a steady task request pattern is detected for five weeks in a row) which may or may not be manually configurable based on user profile and/or other setting.

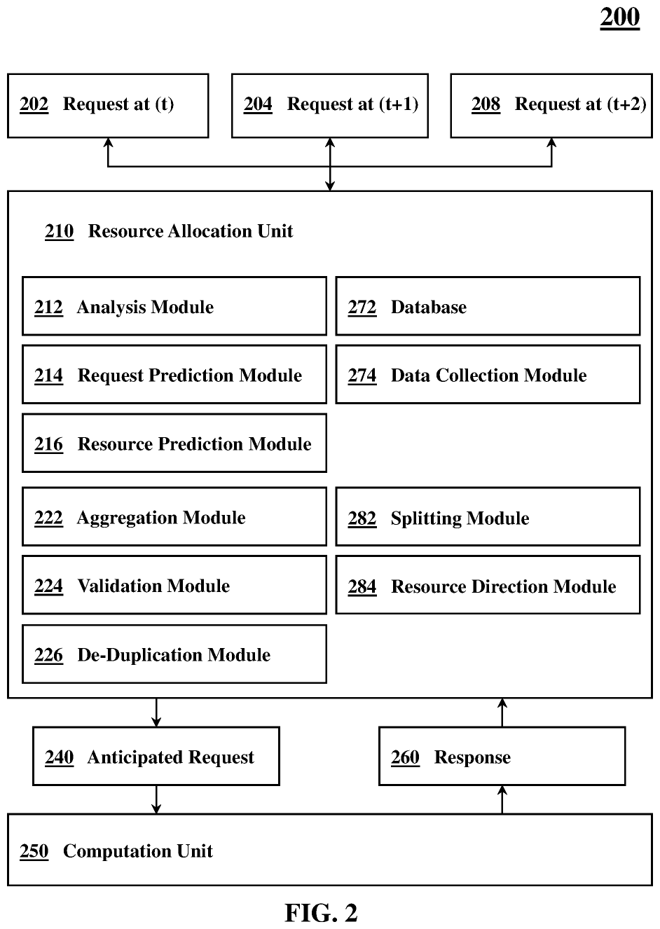

FIG. 2 depicts a workload management system 200 in accordance with some embodiments of the present disclosure. The workload management system 200 includes a resource allocation unit 210 and a computation unit 250. The resource allocation unit 210 may receive requests 202-208 and collect data about the requests 202-208 in a database 272. The resource allocation unit 210 may receive requests 202-208, submit an anticipated request 240 to the computation unit 250, receive a response 260 from the computation unit 250, and submit the response to the relevant request.

The resource allocation unit 210 may receive requests 202-208. The resource allocation unit 210 may analyze the requests 202-208 with an analysis module 212. The analysis module 212 may analyze the requests 202-208 to produce data for the request prediction module 214, resource prediction module 216, aggregation module 222, validation module 224, de-duplication module 226, database 272, and/or resource direction module 284.

The request prediction module 214 may predict regular requests. For example, the request prediction module may identify a pattern of requests such that the incoming request 202 at the current time (e.g., time “t”) will be repeated at the same interval at least twice (e.g., times “t+1” and “t+2”). The request prediction module 214 may predict when these regular task requests will be made (e.g., based on a pattern identified in the historical data kept in the database 272). The request prediction module 214 prediction may be used to optimize resource use. For example, the predicted task may prompt a user with an option to schedule a task for the first off-peak electricity use time after all of the data necessary to compute the request becomes available.

The resource prediction module 216 may predict the resources necessary to execute a request and/or the resources available, presently and/or expected in the future, to execute the requests 202-208. The resource prediction module 216 may consider tasks currently being executed, tasks scheduled for execution, tasks pending execution, tasks predicted to be requested, and the like. For example, the resource prediction module 216 may identify a high priority task will be received within ten minutes that will utilize all available resources for fifteen minutes; the necessary resources for that task may be reserved for that task until its completion.

In some embodiments, the resource prediction module 216 may predict the resource use of the execution of the requests 202-208 if submitted to the computation unit 250 individually as well as the resource use of aggregating and executing the requests 202-208 as an aggregated request 240. In some embodiments, the prediction module 214 may generate one or more comparisons of the resources necessary for the requests 202-208 submitted individually, a single aggregated request, or some combination thereof. The resource prediction module 216 may be used, for example, to predict how to optimize resources via scheduling non-urgent tasks for times with low resource demand and/or decreasing demand during peak hours.

The aggregation module 222 may determine which requests 202-208 may and/or may not be aggregated into an aggregated request 240. The aggregation module 222 may aggregate the requests 202-208 that may be aggregated into an aggregated 240 request for submission to a computation unit 250 for execution. The validation module 224 may be used to validate one or more analyses, predictions, aggregations, duplicative request assessments, restrictions, response splits, resource directions, and the like. The validation module 224 may validate/approve results from one or more modules and/or invalidate results from one or more modules and require action prior to proceeding. The de-duplication module 226 may de-duplicate any duplicative requests.

The resource allocation unit 210 may predict an anticipated request 240, submit the anticipated request 240 to the computation unit 250, receive a response 260 for the anticipated request 240 from the computation unit 250, and submit a response to the relevant request.

The resource allocation unit 210 may send an anticipated request 240 (e.g., predicted by the request prediction module 214) to the computation unit 250. In some embodiments, the computation unit 250 may execute the anticipated request 240 to achieve a response 260 to the anticipated request 240; the computation unit 250 may send the response 260 to the resource allocation unit 210. In some embodiments, the computation unit 250 may schedule the anticipated request 240 (e.g., selects a time to execute the anticipated request 240) so as to allocate resources for the anticipated request 240 for a later time (e.g., when the anticipated request 240 is realized such that the request is received). The computation unit 250 may execute the relevant task received from the user at the specified time and/or the computation unit 250 may execute the anticipated request 240 at the specified time.

In some embodiments, the computation unit 250 may execute the anticipated request 240 and the actual task request may be different from the anticipated request 240. In some embodiments, the resource allocation unit 210 may use a splitting module 282 to split the response 260 so as to respond to the actual user inquiry. For example, if an anticipated request 240 was executed for the total number of shirts, shoes, and shorts sold during the previous week but the actual user inquiry was only for the total number of shirts sold during the previous week, then the splitting module 282 may be used to separate out the total number of shirts sales and submit that part of the response 260 to the user.

Data (e.g., results from modules in the resource allocation unit 210 and/or the computation unit 250) and/or requests 202-208 may be stored in the database 272 to build the historical data record. The database 272 may include data from and/or about requests submitted to the system 200, data received from an external data collection, data collected with a data collection module 274, data achieved with the computation unit 250, and the like.

The analysis module 212 may analyze both incoming requests 202-208 and historical data stored in a database 272. The analysis module 212 may render an analysis to a request prediction module 214 and/or resource prediction module 216. The prediction modules may use the analysis to determine and/or enhance predicted task schedules, predicted resource allocations, predicted requests projected to be submitted to the system 200, and the like.

Data in the database 272 may be used to generate a predicted schedule of tasks for one or more users. In some embodiments, the data may be used to optimize resource availability and/or expenditure by scheduling regular tasks. In some embodiments, an administrator may identify one or more thresholds to trigger automatic scheduling of regular tasks (e.g., a steady task request pattern is detected for twelve months in a row) which may or may not be manually configurable based on user profile and/or other setting.

The resource allocation unit 210 may include a resource direction module 284. The resource direction module 284 may determine where certain resources in the system 200 would be best utilized and/or for which tasks and/or at which times. In some embodiments, the resource allocation unit 210 may receive requests 202-208, prioritize and identify resource requirements, and predict forthcoming tasks and required resources; the resource direction module 284 may allocate system resources (e.g., computing power, memory, storage, and time) according to the tasks, prioritizations, and predictions. For example, the request prediction module 214 may predict arrival of a high priority task within five minutes requiring half of the available computation power, and the resource direction module 284 may reserve resources for that task.

A computer-implemented method in accordance with the present disclosure may include acquiring historical data and identifying a pattern in the historical data. The method may include predicting a predicted task request based on the historical data and the pattern such that the predicted task request anticipates a task request. The method may include calculating predicted resource requirements for the predicted task request and allocating resources for the predicted task request. The method may include receiving the task request and assigning the allocated resources to the task request. The method may include deploying the allocated resources for the task request.

In some embodiments of the present disclosure, the method may include calculating a predicted resource requirement for the predicted task request. In some embodiments of the present disclosure, the method may further include detecting an existing resource allocation schedule and scheduling the predicted task request in the existing resource allocation schedule. In some embodiments of the present disclosure, the method may further include forecasting available resources during a future deployment time window and scheduling the predicted task request based on the available resources.

In some embodiments of the present disclosure, the method may include scaling resources for the predicted task request.

In some embodiments of the present disclosure, the method may include prioritizing the task request among a set of tasks.

In some embodiments of the present disclosure, the method may include balancing a task load based on system resource availability. The task load may include the task request and a set of tasks.

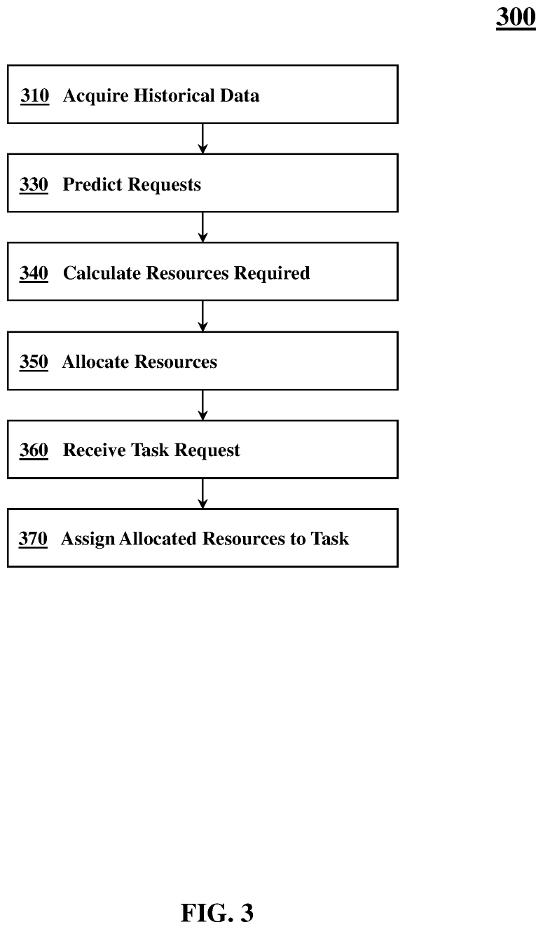

FIG. 3 illustrates a computer-implemented workload management method 300 in accordance with some embodiments of the present disclosure. The method 300 includes acquiring 310 historical data. Historical data may include, for example, task request information, task request metadata (e.g., the timing of a task request), previous task request predictions (e.g., predicted times and predicted resource requirements), previous task request realizations (e.g., which task requests were received, the timing of the receipt of tasks, and the actual resources used to execute the tasks), system resource availability during various task executions (e.g., the amount of strain tasks placed on the system and the resources remaining for other tasks), the predicted cost of using resources to execute the tasks (e.g., the predicted kilowatt hours spent on a task and the predicted price per kilowatt hour), the actual cost of using resources to execute tasks (e.g., the realized kilowatt hours spent on an executed task and the realized price per kilowatt hour for executing the task at the time it was executed), and the like.

The workload management method 300 includes predicting 330 requests; requests may be predicted based on historical data, user inputs (e.g., scheduled tasks), and similar information. The workload management method 300 includes calculating 340 the resources required for the predicted requests; required resources may include, for example, computing power, storage, memory, time, energy cost, and the like which may be required to compute tasks. The workload management method 300 includes allocating 350 resources for the predicted requests; allocating 350 resources may include, for example, selecting which resources to use for which task and when the resources will be used to execute the task.

The method 300 includes receiving 360 a task request (e.g., via manual user input or a task schedule) and assigning 370 the allocated resources to that task. For example, a system (e.g., the system 200 of FIG. 2) may receive requests (e.g., requests 202-208 of FIG. 2) which resources were allocated for (e.g., because the requests were predicted); the resources may be directed to the requests (e.g., by the resource direction module 284 of FIG. 2) for task execution.

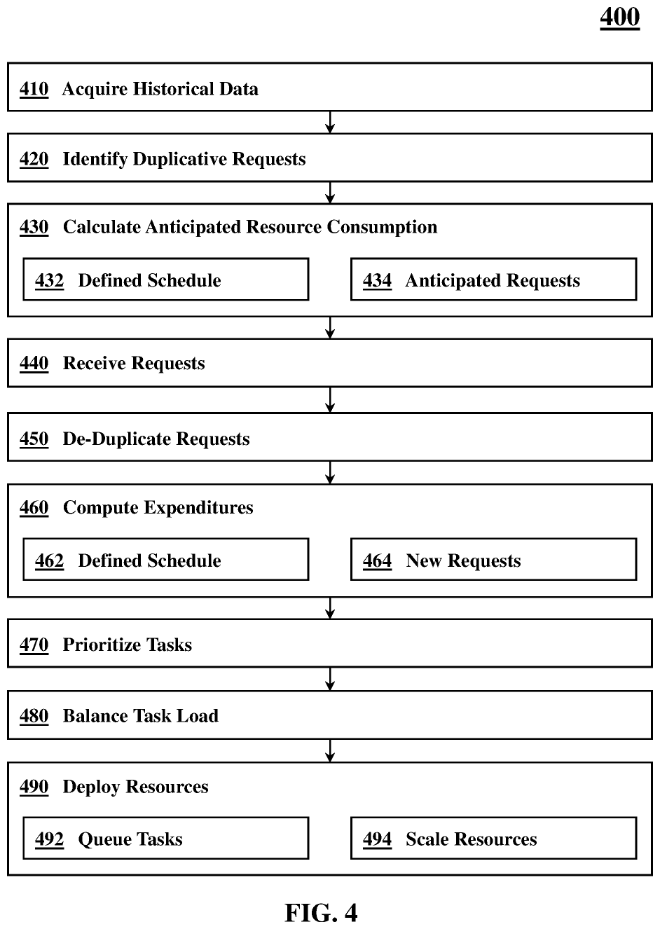

FIG. 4 depicts a computer-implemented workload management method 400 in accordance with some embodiments of the present disclosure. The method 400 includes acquiring 410 historical data, identifying 420 duplicative requests, and calculating 430 anticipated resource consumption. Calculating 430 anticipated resource consumption may consider, for example, a defined schedule 432 and anticipated requests 434. The defined schedule 432 may include, for example, pre-determined and/or pre-set tasks that one or more users has selected to be executed at a specific time and/or tasks that a system (e.g., the workload management system 200 of FIG. 2) has scheduled for a specific time. The defined schedule 432 may or may not be malleable depending on, for example, prioritization rules and/or user settings.

Calculating 430 anticipated resource consumption may consider one or more anticipated requests 434. The anticipated requests 434 may include, for example, predicted individual requests (e.g., predicted by the request prediction module 214 of FIG. 2) and/or predicted aggregated requests (e.g., aggregated request 140 which may have been predicted by prediction module 114 of FIG. 1).

The workload management method 400 includes receiving 440 requests, de-duplicating 450 requests, and computing 460 expenditures. Expenditures computed may include necessary resources expenditures for task execution such as, for example, computing power, random access memory (RAM), storage, time, and the like. Computing 460 expenditures may consider a defined schedule 462 and/or one or more new requests 464. The defined schedule 462 may include, for example, pre-determined and/or pre-set tasks that one or more users selected for execution for a specific date and/or time, predicted tasks, tasks that a system (e.g., the workload management system 200 of FIG. 2) scheduled for a specific date and/or time, and/or tasks that a user or system have selected for execution within a defined time window. New requests 464 may include received tasks that were unpredicted (e.g., an entirely new type of request and/or a request without an established pattern) and/or tasks received by the system at unpredicted times.

The method 400 includes prioritizing 470 tasks, balancing 480 the task load, and deploying 490 resources for tasks. Deploying 490 resources may include queuing 492 tasks and/or scaling 494 resources. For example, a system may determine that a cluster of received tasks is to be performed in a certain order, and the system may engage in deploying 490 the task cluster by queuing 492 the tasks in the certain order such that a subsequent task will be executed when the preceding task is completed. In some circumstances, the system may determine that the SLA, SLO, and the budget (and/or other organizational settings) permit scaling 494 resources up and/or out for a pending task; the system may thus engage in deploying 490 resources by scaling 494 the resources to meet the demands of the pending task in accordance with the SLA, SLO, and budget. In some embodiments, the system may both queue tasks and scale resources to execute tasks.

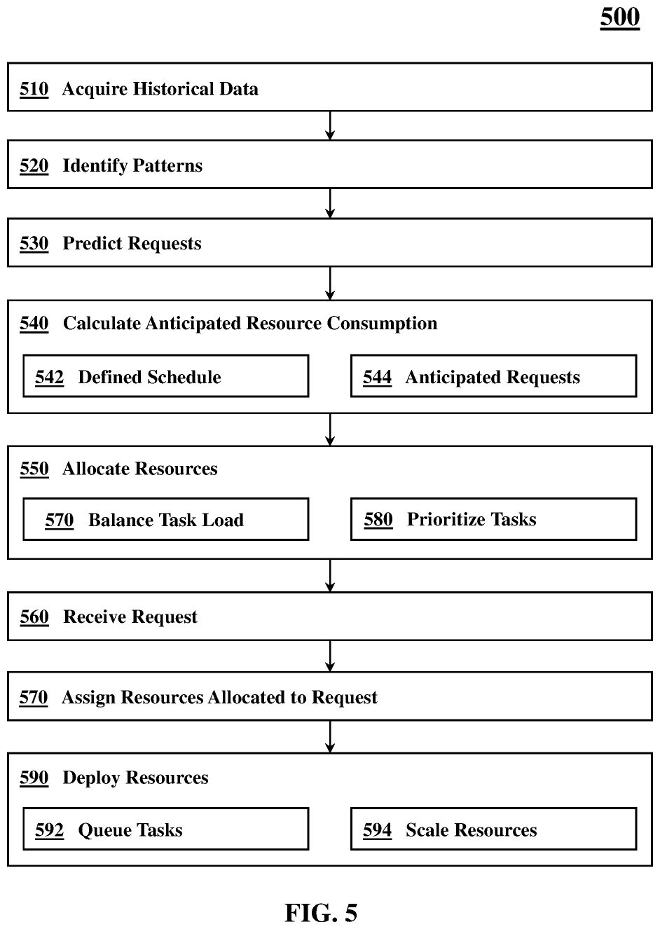

FIG. 5 illustrates a computer-implemented workload management method 500 in accordance with some embodiments of the present disclosure. The method 500 includes acquiring 510 historical data, identifying 520 patterns in the historical data, and predicting 530 requests based on the patterns in the historical data. The workload management method 500 includes calculating 540 anticipated resource consumption and allocating 550 resources. The method 500 includes receiving 560 a request, assigning 570 resources allocated to the request, and deploying 590 resources for tasks.

The workload management method 500 includes calculating 540 anticipated resource consumption. Calculating 540 anticipated resource consumption may include calculating 540 anticipated resource expenditures. Anticipated expenditures may include necessary resources expenditures such as, for example, computing power, storage, compute time, and the like.

Calculating 540 anticipated resource consumption may include considering a defined schedule 542 and/or one or more anticipated requests 544. The defined schedule 542 may include, for example, pre-determined and/or pre-set tasks that one or more users selected for execution for a specific date and/or time and/or tasks that a system (e.g., the workload management system 200 of FIG. 2) scheduled for a specific date and/or time. The defined schedule 542 may or may not be malleable depending on, for example, prioritization rules and/or user settings.

Calculating 540 anticipated resource consumption may consider one or more anticipated requests 544. The one or more anticipated requests 544 may be predicted via the predicting 530 requests operation of the workload management method 500 (which may be performed, for example, by the prediction module 114 of FIG. 1). The anticipated requests 544 may include, for example, predicted individual requests (e.g., predicted by the request prediction module 214 of FIG. 2) and/or predicted aggregated requests (e.g., the aggregated request 140 which may have been predicted by prediction module 114 of FIG. 1).

The workload management method 500 includes allocating 550 resources. Allocating 550 resources may include balancing 570 a task load and/or prioritizing 580 tasks. Allocating 550 may include, for example, scheduling resources to be assigned to scheduled and/or predicted tasks at certain times based on task load balance, task priority, and the like. The allocated resources may be used for executing the requested task.

The method 500 includes receiving 560 a request and assigning 570 resources allocated to the request. Assigning 570 resources allocated to a task request may include, for example, identifying that a task request has been allocated resources (e.g., via the allocating 550 resources operation) and directing the allocated resources to that task request (e.g., via a resource direction module 284 as shown in FIG. 2). The resources may be used to execute the requested task.

The method 500 includes deploying 590 resources. Deploying 590 resources may include queuing 592 tasks and/or scaling 594 resources to meet task requirements. For example, a system may determine that several tasks with the same priority are to be executed one after another in the order received, queuing 592 the tasks to achieve the desired result. In some circumstances, the system may determine that the SLA and budget of an entity require scaling 594 resources up and/or out for a priority task; immediately deploying 590 resources by scaling 594 the resources to meet the demands of the priority task may be required by the SLA and permitted by the budget of that entity.

A computer program product in accordance with the present disclosure may include a computer readable storage medium having program instructions embodied therewith. The program instructions may be executable by a processor to cause the processor to perform a function. The function may include predicting a predicted task request based on the historical data and the pattern such that the predicted task request anticipates a task request. The function may include calculating predicted resource requirements for the predicted task request and allocating resources for the predicted task request. The function may include receiving the task request and assigning the allocated resources to the task request. The function may include deploying the allocated resources for the task request.

In some embodiments of the present disclosure, the function may include calculating a predicted resource requirement for the predicted task request. In some embodiments of the present disclosure, the function may further include forecasting available resources during a future deployment time window and scheduling the predicted task request based on the available resources. In some embodiments of the present disclosure, the function may further include detecting an existing resource allocation schedule and scheduling the predicted task request in the existing resource allocation schedule.

In some embodiments of the present disclosure, the function may include scaling resources for the predicted task request.

In some embodiments of the present disclosure, the function may include prioritizing the task request among a set of tasks.

In some embodiments of the present disclosure, the function may include balancing a task load based on system resource availability. The task load may include the task request and a set of tasks.

It is noted that various aspects of the present disclosure may be described by narrative text, flowcharts, block diagrams of computer systems, and/or block diagrams of the machine logic included in computer program product (CPP) embodiments. With respect to any flowcharts (depending upon the technology involved), the operations can be performed in a different order than what is shown in the flowchart. For example, two operations shown in successive flowchart blocks may be performed in reverse order, as a single integrated step, concurrently, or in a manner at least partially overlapping in time. A computer program product embodiment (“CPP embodiment”) is a term used in the present disclosure that may describe any set of one or more storage media (or “mediums”) collectively included in a set of one or more storage devices.

The storage media may collectively include machine readable code corresponding to instructions and/or data for performing computer operations. A “storage device” may refer to any tangible hardware or device that can retain and store instructions for use by a computer processor. Without limitation, the computer readable storage medium may include an electronic storage medium, a magnetic storage medium, an optical storage medium, an electromagnetic storage medium, a semiconductor storage medium, a mechanical storage medium, and/or any combination thereof. Some known types of storage devices that include mediums referenced herein may include a diskette, hard disk, RAM, read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc), or any suitable combination thereof. A computer-readable storage medium should not be construed as storage in the form of transitory signals per se such as radio waves, other freely propagating electromagnetic waves, electromagnetic waves propagating through a waveguide, light pulses passing through a fiber optic cable, electrical signals communicated through a wire, and/or other transmission media. As understood by those skilled in the art, data is typically moved at some occasional points in time during normal operations of a storage device, such as during access, de-fragmentation, or garbage collection, but this does not render the storage device transitory because the data is not transitory while it is stored.

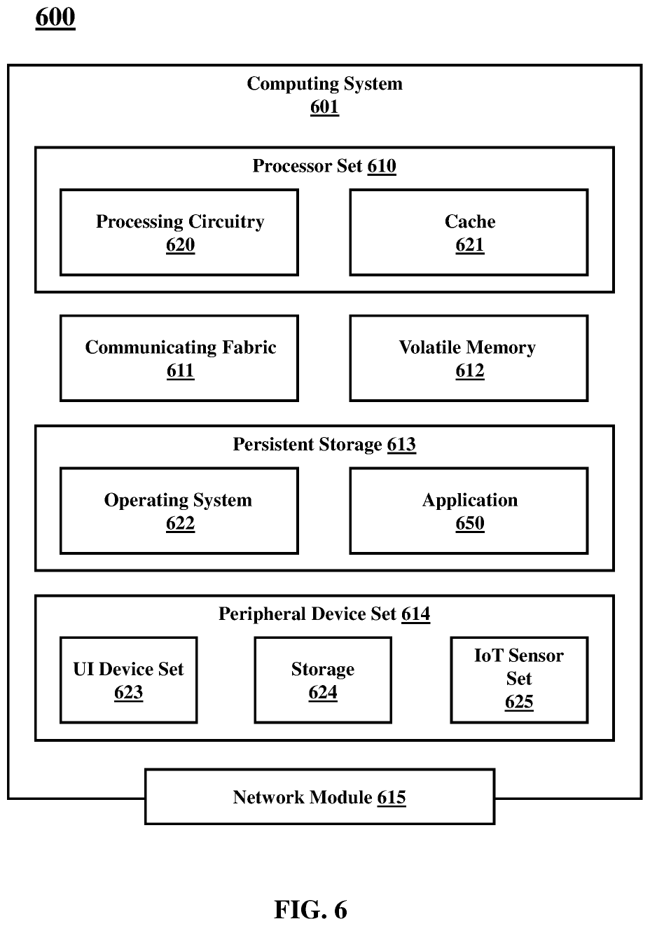

Referring now to FIG. 6, illustrated is a block diagram describing an embodiment of a computing system 601 within in a computing environment 600. The computing environment 600 may be a simplified example of a computing device (e.g., a physical bare metal system and/or a virtual system) capable of performing the computing operations described herein. The computing system 601 may be representative of the one or more computing systems or devices implemented in accordance with the embodiments of the present disclosure and further described below in detail. It should be appreciated that FIG. 6 provides only an illustration of one implementation of a computing system 601 and does not imply any limitations regarding the environments in which different embodiments may be implemented. In general, the components illustrated in FIG. 6 may be representative of an electronic device, either physical or virtualized, capable of executing machine-readable program instructions.

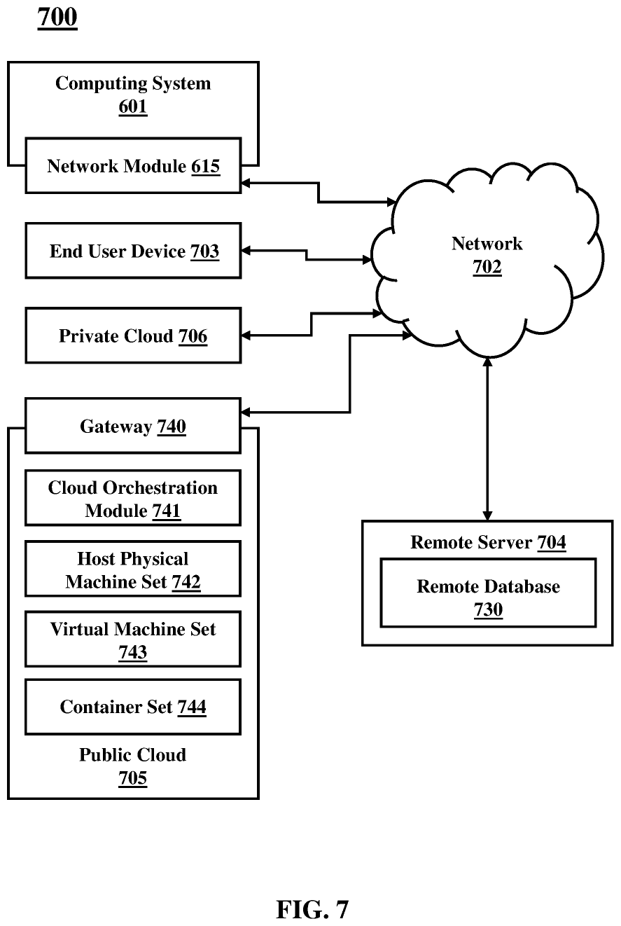

Embodiments of computing system 601 may take the form of a desktop computer, laptop computer, tablet computer, smart phone, smart watch or other wearable computer, mainframe computer, server, quantum computer, a non-conventional computer system such as an autonomous vehicle or home appliance, or any other form of computer or mobile device now known or to be developed in the future that is capable of running an application 650, accessing a network (e.g., network 702 of FIG. 7), or querying a database (e.g., remote database 730 of FIG. 7). Performance of a computer-implemented method executed by a computing system 601 may be distributed among multiple computers and/or between multiple locations. The computing system 601 may be located as part of a cloud network, even though it is not shown within a cloud in FIG. 6 or FIG. 7. Moreover, the computing system 601 is not required to be in a cloud network except to any extent as may be affirmatively indicated.

The processor set 610 includes one or more computer processors of any type now known or to be developed in the future. Processing circuitry 620 may be distributed over multiple packages such as, for example, multiple coordinated integrated circuit chips. Processing circuitry 620 may implement multiple processor threads and/or multiple processor cores. The cache 621 may refer to memory that is located on the processor chip package(s) and/or may be used for data and/or code that can be made available for rapid access by the threads or cores running on the processor set 610. Cache 621 memories may be organized into multiple levels depending upon relative proximity to the processing circuitry 620. Alternatively, some or all of the cache 621 may be located “off chip.” In some computing environments, the processor set 610 may be designed for working with qubits and performing quantum computing.

Computer readable program instructions can be loaded onto the computing system 601 to cause a series of operational steps to be performed by the processor set 610 of the computing system 601 and thereby implement a computer-implemented method. Execution of the instructions can instantiate the methods specified in flowcharts and/or narrative descriptions of computer-implemented methods included in this specification (collectively referred to as “the inventive methods”). The computer readable program instructions can be stored in various types of computer readable storage media, such as cache 621 and the other storage media discussed herein. The program instructions, and associated data, can be accessed by the processor set 610 to control and direct performance of the inventive methods. In the computing environments of FIG. 6 and FIG. 7, at least some of the instructions for performing the inventive methods may be stored in persistent storage 613, volatile memory 612, and/or cache 621 as application(s) 650 comprising one or more running processes, services, programs, and installed components thereof. For example, program instructions, processes, services, and installed components thereof may include the components and/or sub-components of the workload management system 100 as shown in FIG. 1 and/or the components and/or sub-components of the workload management system 200 as shown in FIG. 2. For example, program instructions, processes, services, and installed components thereof may include the components and/or sub-components of the computer-implemented workload management method 300 as shown in FIG. 3, the computer-implemented workload management method 400 as shown in FIG. 4, and/or the computer-implemented workload management method 500 as shown in FIG. 5.

The communication fabric 611 may refer to signal conduction paths that may allow the various components of the computing system 601 to communicate with each other. For example, communications fabric 611 may provide for electronic communication among the processor set 610, volatile memory 612, persistent storage 613, peripheral device set 614, and/or network module 615. The communication fabric 611 may be made of switches and/or electrically conductive paths, such as the switches and electrically conductive paths that make up busses, bridges, physical input/output ports, and the like. Other types of signal communication paths may be used such as fiber optic communication paths and/or wireless communication paths.

The volatile memory 612 may refer to any type of volatile memory now known or to be developed in the future. The volatile memory 612 may be characterized by random access; random access is not required unless affirmatively indicated. Examples include dynamic-type RAM and static-type RAM. In the computing system 601, the volatile memory 612 is located in a single package and can be internal to computing system 601; in some embodiments, either alternatively or additionally, the volatile memory 612 may be distributed over multiple packages and/or located externally with respect to the computing system 601. The application 650, along with any program(s), processes, services, and installed components thereof, described herein, may be stored in volatile memory 612 and/or persistent storage 613 for execution and/or access by one or more of the respective processor sets 610 of the computing system 601.

Persistent storage 613 may be any form of non-volatile storage for computers that may be currently known or developed in the future. The non-volatility of this storage means that the stored data may be maintained regardless of whether power is being supplied to the computing system 601 and/or directly to persistent storage 613. Persistent storage 613 may be a ROM; at least a portion of the persistent storage 613 may allow writing of data, deletion of data, and/or re-writing of data. Some forms of persistent storage 613 may include magnetic disks, solid-state storage devices, hard drives, flash-based memory, erasable read-only memories (EPROM), and semi-conductor storage devices. An operating system 622 may take several forms, such as various known proprietary operating systems or open-source portable operating system interface-type operating systems that employ a kernel.

The peripheral device set 614 may include one or more peripheral devices connected to the computing system 601, for example, via an input/output (I/O) interface. Data communication connections between the peripheral devices and the other components of the computing system 601 may be implemented using various methods. For example, data communication connections may be made using short-range wireless technology (e.g., a Bluetooth® connection), near-field communication (NFC), wired connections or cables (e.g., universal serial bus (USB) cables), insertion-type connections (e.g., a secure digital (SD) card), connections made though local area communication networks, wide area networks (e.g., the internet), and the like.

In various embodiments, the UI device set 623 may include components such as a display screen, speaker, microphone, wearable devices (e.g., goggles, headsets, and/or smart watches), keyboard, mouse, printer, touchpad, game controllers, and/or haptic feedback devices.

The storage 624 may include internal storage, external storage (e.g., an external hard drive), or insertable storage (e.g., an SD card). The storage 624 may be persistent and/or volatile. In some embodiments, the storage 624 may take the form of a quantum computing storage device for storing data in the form of qubits.

In some embodiments, networks of computing systems 601 may utilize clustered computing and components acting as a single pool of seamless resources when accessed through a network by one or more computing systems 601. For example, networks of computing systems 601 may utilize a storage area network (SAN) that is shared by multiple, geographically distributed computer systems 601 or network-attached storage (NAS) applications.

An IoT sensor set 625 may be made up of sensors that can be used in Internet-of-Things applications. A sensor may be a temperature sensor, motion sensor, infrared sensor, and/or any other type of sensor. One or more sensors may be communicably connected and/or used as the IoT sensor set 625 in whole or in part.

The network module 615 may include a collection of computer software, hardware, and/or firmware that allows the computing system 601 to communicate with other computer systems through a network 602 such as a LAN or WAN. The network module 615 may include hardware (e.g., modems or wireless signal transceivers), software (e.g., for packetizing and/or de-packetizing data for communication network transmission), and/or web browser software (e.g., for communicating data over the network).

In some embodiments, network control functions and network forwarding functions of the network module 615 may be performed on the same physical hardware device. In some embodiments, the control functions and the forwarding functions of network module 615 may be performed on physically separate devices such that the control functions manage several different network hardware devices; for example, embodiments that utilize software-defined networking (SDN) may perform control functions and forwarding functions of the network module 615 on physically separate devices. Computer readable program instructions for performing the inventive methods may be downloaded to the computing system 601 from an external computer or external storage device through a network adapter card and/or network interface included in the network module 615.

Continuing, FIG. 7 depicts a computing environment 700 operating as part of a network. The computing environment 700 of FIG. 7 may be an extension of the computing environment 600 of FIG. 6. In addition to the computing system 601, the computing environment 700 may include a network 702 (e.g., a WAN or other type of computer network) connecting the computing system 601 to an end user device (EUD) 703, remote server 704, public cloud 705, and/or private cloud 706.

In this embodiment, computing system 601 includes processor set 610 (including the processing circuitry 620 and the cache 621), the communication fabric 611, the volatile memory 612, the persistent storage 613 (including the operating system 622 and the program(s) 650, as identified above), the peripheral device set 614 (including the user interface (UI), the device set 623, the storage 624, and the Internet of Things (IOT) sensor set 625), and the network module 615 of FIG. 6.

In this embodiment, the remote server 704 includes the remote database 730. In this embodiment, the public cloud 705 includes gateway 740, cloud orchestration module 741, host physical machine set 742, virtual machine set 743, and/or container set 744.

The network 702 may be comprised of wired and/or wireless connections. For example, connections may be comprised of computer hardware such as copper transmission cables, optical transmission fibers, wireless transmission, routers, firewalls, switches, gateway computers, and/or edge servers. The network 702 may be described as a WAN (e.g., the internet) capable of communicating computer data over non-local distances by any technology for communicating computer data; the network 702 may make use of technology now known or to be developed in the future. In some embodiments, the WAN may be replaced and/or supplemented by LANs designed to communicate data between devices located in a local area (e.g., a wireless network). Other types of networks that can be used to interconnect the one or more computer systems 601, EUDs 703, remote servers 704, private cloud 706, and/or public cloud 705 may include a Wireless Local Area Network (WLAN), home area network (HAN), backbone network (BBN), peer to peer network (P2P), campus network, enterprise network, the Internet, single- or multi-tenant cloud computing networks, the Public Switched Telephone Network (PSTN), and any other network or network topology known by a person skilled in the art to interconnect computing systems 601.

The EUD 703 may include any computer device that can be used and/or controlled by an end user; for example, a customer of an enterprise that operates the computing system 601. The EUD 703 may take any of the forms discussed above in connection with computing system 601. The EUD 703 may receive helpful and/or useful data from the operations of the computing system 601. For example, in a hypothetical case where the computing system 601 provides a recommendation to an end user, the recommendation may be communicated from the network module 615 of the computing system 601 through a WAN network 702 to the EUD 703; in this example, the EUD 703 may display (or otherwise present) the recommendation to an end user. In some embodiments, the EUD 703 may be a client device (e.g., a thin client), thick client, mobile computing device (e.g., a smart phone), mainframe computer, desktop computer, and/or the like.

A remote server 704 may be any computing system that serves at least some data and/or functionality to the computing system 601. The remote server 704 may be controlled and used by the same entity that operates the computing system 601. The remote server 704 represents the one or more machines that collect and store helpful and/or useful data for use by other computers (e.g., computing system 601). For example, in a hypothetical case where the computing system 601 is designed and programmed to provide a recommendation based on historical data, the historical data may be provided to the computing system 601 via a remote database 730 of a remote server 704.

Public cloud 705 may be any computing systems available for use by multiple entities that provide on-demand availability of computer system resources and/or other computer capabilities including data storage (e.g., cloud storage) and computing power without direct active management by the user. The direct and active management of the computing resources of the public cloud 705 may be performed by the computer hardware and/or software of a cloud orchestration module 741. The public cloud 705 may communicate through the network 702 via a gateway 740; the gateway 740 may be a collection of computer software, hardware, and/or firmware that allows the public cloud 705 to communicate through the network 702.

The computing resources provided by the public cloud 705 may be implemented by a virtual computing environment (VCE) or multiple VCEs that may run on one or more computers making up a host physical machine set 742 and/or the universe of physical computers in and/or available to public cloud 605. A VCE may take the form of a virtual machine (VM) from the virtual machine set 743 and/or containers from the container set 744.

VCEs may be stored as images. One or more VCEs may be stored as one or more images and/or may be transferred among and/or between one or more various physical machine hosts either as images and/or after instantiation of the VCE. A new active instance of the VCE may be instantiated from the image. Two types of VCEs may include VMs and containers. A container is a VCE that uses operating system-level virtualization in which the kernel may allow the existence of multiple isolated user-space instances called containers. These isolated user-space instances may behave as physical computers from the point of view of the programs 650 running in them. An application 650 running on an operating system 622 may utilize all resources of that computer such as connected devices, files, folders, network shares, CPU power, and quantifiable hardware capabilities. The applications 650 running inside a container of the container set 644 may only use the contents of the container and devices assigned to the container; this feature may be referred to as containerization. The cloud orchestration module 741 may manage the transfer and storage of images, deploy new instantiations of one or more VCEs, and manage active instantiations of VCE deployments.

Private cloud 706 may be similar to public cloud 705 except that the computing resources may only be available for use by a single enterprise. While the private cloud 706 is depicted as being in communication with the network 702 (e.g., the Internet), in other embodiments, a private cloud 606 may be disconnected from the internet entirely and only accessible through a local/private network.

In some embodiments, a hybrid cloud may be used; a hybrid cloud may refer to a composition of multiple clouds of different types (e.g., private, community, and/or public cloud types). In a hybrid cloud system, the plurality of clouds may be implemented or operated by different vendors. Each of the multiple clouds remains a separate and discrete entity; the larger hybrid cloud architecture is bound together by standardized or proprietary technology that enables orchestration, management, and/or data/application portability between the multiple constituent clouds. In this embodiment, the public cloud 705 and the private cloud 706 may be both part of a larger hybrid cloud environment.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
acquiring historical data;
identifying a pattern in said historical data;
predicting a predicted task request based on said historical data and said pattern, wherein said predicted task request anticipates a task request;
calculating predicted resource requirements for said predicted task request;
allocating resources for said predicted task request;
receiving said task request;
assigning said allocated resources to said task request; and
deploying said allocated resources for said task request.

2. The system of claim 1, said operations further comprising:
calculating a predicted resource requirement for said predicted task request.

3. The system of claim 2, said operations further comprising:
detecting an existing resource allocation schedule; and
scheduling said predicted task request in said existing resource allocation schedule.

4. The system of claim 2, said operations further comprising:
forecasting available resources during a future deployment time window; and
scheduling said predicted task request based on said available resources.

5. The system of claim 1, said operations further comprising:
scaling resources for said predicted task request.

6. The system of claim 1, said operations further comprising:
prioritizing said task request among a set of tasks.

7. The system of claim 1, said operations further comprising:
balancing a task load based on system resource availability, wherein said task load includes said task request and a set of tasks.

8. A computer-implemented method, said method comprising:
acquiring historical data;
identifying a pattern in said historical data;
predicting a predicted task request based on said historical data and said pattern, wherein said predicted task request anticipates a task request;
calculating predicted resource requirements for said predicted task request;
allocating resources for said predicted task request;
receiving said task request;
assigning said allocated resources to said task request; and
deploying said allocated resources for said task request.

9. The method of claim 8, further comprising:
calculating a predicted resource requirement for said predicted task request.

10. The method of claim 9, further comprising:
detecting an existing resource allocation schedule; and
scheduling said predicted task request in said existing resource allocation schedule.

11. The method of claim 9, further comprising:
forecasting available resources during a future deployment time window; and
scheduling said predicted task request based on said available resources.

12. The method of claim 8, further comprising:
scaling resources for said predicted task request.

13. The method of claim 8, further comprising:
prioritizing said task request among a set of tasks.

14. The method of claim 8, further comprising:
balancing a task load based on system resource availability, wherein said task load includes said task request and a set of tasks.

15. A computer program product, said computer program product comprising a computer readable storage medium having program instructions embodied therewith, said program instructions executable by a processor to cause said processor to perform a function, said function comprising:
acquiring historical data;
identifying a pattern in said historical data;
predicting a predicted task request based on said historical data and said pattern, wherein said predicted task request anticipates a task request;
calculating predicted resource requirements for said predicted task request;
allocating resources for said predicted task request;
receiving said task request;
assigning said allocated resources to said task request; and
deploying said allocated resources for said task request.

16. The computer program product of claim 15, said function further comprising:
calculating a predicted resource requirement for said predicted task request.

17. The computer program product of claim 16, said function further comprising:
forecasting available resources during a future deployment time window; and
scheduling said predicted task request based on said available resources.

18. The computer program product of claim 15, said function further comprising:
scaling resources for said predicted task request.

19. The computer program product of claim 15, said function further comprising:
prioritizing said task request among a set of tasks.

20. The computer program product of claim 15, said function further comprising:
balancing a task load based on system resource availability, wherein said task load includes said task request and a set of tasks.
